(19) United States
(12) Patent Application Publication
(10) Pub. No.: US 2007/0003120 A1
(43) Pub. Date: Jan. 4, 2007

(54) AUTOMATIC ANALYSIS OF CELLULAR SAMPLES

(75) Inventor: Christian Pinset, Paris (FR)

Correspondence Address: POLSINELLI SHALTON WELTE SUELTHAUS P.C., 700 W. 47TH STREET, SUITE 1000, KANSAS CITY, MO, 64112-1802, US

(73) Assignee: CELOGOS, Paris (FR)

(21) Appl. No.: 11/381,814

(22) Filed: May 5, 2006

(30) Foreign Application Priority Data
Nov. 5, 2004 (WO) PCT/FR04/02854
Nov. 7, 2003 (FR) 03 13 121

(51) Int. Cl. G06K 9/00

(52) U.S. Cl. 382/129

(57) ABSTRACT

The inventive method for automatically analysing a cellular sample consists (a) in colouring the cell nucleuses of a sample, (b) inobtaining at least one digital picture of the sample, and (c) in digitally analysing said image and is characterised in that the cell nucleus colouring stage (2) is embodied in the form of a DNA-non-specific colouring. In order to use the inventive method, said invention also relates to a method for selecting a culture medium, a method for measuring substance toxicity and to a method for measuring the cytopathological characteristics of a virus. A method for selecting pharmacological substances for treating excess weight and obesity diseases and a method for selecting substances for treating osteoporosis are also disclosed.

### FIELD OF INVENTION

The present invention relates to a process for analysing a cellular sample. The invention also relates to a process for analysing a digital image of a cellular sample to be utilised by software. The invention further relates to a device for analysing cellular samples.

### BACKGROUND OF INVENTION

The number of industrial and cognitive applications of culture cells is constantly growing. The following applications constitute an inexhaustive list of examples:
cells for the production of recombinant proteins,
cells for screening pharmacological molecules,
cells for diagnostic tests,
cells for constructing predictive toxicology,
cells for the cellular therapy of reconstruction repair and regeneration.

Numerous factors make full exploitation of the potential of culture cells even more difficult. These factors are inter alia:
the manual character of excessively numerous technical operations making the notion of knowhow extremely critical,
the use of numerous indefinite factors entering the culture media, and
the qualitative and quantitative poverty of the most diffuse cellular systems.

These reasons explain that at the present moment techniques of cellular couture are closer to a sum of knowhow than a technology, which could be industrialised.

The quantification of the number of cells and their morphological analysis is a critical element for cellular followup. Currently, for the most part, this activity is manual and dependent on a knowhow of the operator. In addition, the usual methods for determining the number of attached cells are associated with stages of detachment or cellular lysis. For this very reason these techniques are doing away with all morphological notions and lead to significant information losses.

Therefore, there is a need to facilitate and accelerate quantitative and/or qualitative analysis of the nuclei in the cellular samples, such as analysis of morphology or distribution. Said cellular samples can be either tissue samples originating from a biopsy, of primary cultures of cells or cultures of cellular lines and are not limited to any particular origin. The aim of the invention is to assist in satisfying this need and focuses especially on at least partially automating this analysis while allowing a simple and economical procedure in time and means.

### SUMMARY OF THE INVENTION

To this end, the present invention proposes an analysis process of a cellular sample, comprising the stages of:
a) colouring the nuclei of the cells of the sample;
b) acquisition of at least one digital image of the sample;
c) digital analysis of said image.

According to preferred embodiments, the process comprises one or more of the following characteristics:
colouring stage a) comprises cytochemical colouring
colouring stage a) comprises the use of an immunoenzymatic technique with at least one antibody;
colouring stage a) comprises the use of a immunoperoxidase technique with at least one antibody;
colouring stage a) of the nuclei of the cells is DNA-non-specific colouring;
between the stages b) and c), the process comprises a decomposition stage of the image according to a given colour;
decomposition stage of the image is completed according to either the colour of the colouring, or according to the colour complementary to the colouring;
decomposition stage is completed according to one of the primary colours of the standard Nrgb space;
the colouring is magenta, the decomposition stage colorimetry being conducted according to the green compound of the standard space of colorimetry;
prior to stage c), the process comprises a binarisation stage of the pixels of the image to bring out the nuclei of the cells on a background;
binarisation stage is effected by application of the Ridler algorithm to the decomposed image according to said given colour;
prior to stage c), the process comprises an elimination stage in the binarised image of at least one object having a number of pixels less than a first predetermined threshold;
prior to stage c), the process comprises a division stage, in the binarised image, of at least one object having a number of pixels greater than a second predetermined threshold, into as many objects as nuclei of cells corresponding to this object;
division stage comprises the ultimate erosion of said at least one object for supplying germs, then growth of said germs for determining lines of division for the object by application of the watershed method;
stage c) comprises counting of the objects of the image.

According to another aspect, the invention also proposes an analysis process of a digital image of a cellular sample to be utilised by software, each pixel of the image being defined by a level of intensity of at least one compound colour or black and white from amongst a number of possible levels of intensity greater than two, the process comprising the stages of:
binarisation of the pixels of the image to bring out the nuclei of the cells on a background; and
analysis of the binarised image.

According to preferred embodiments, the process comprises one or more of the following characteristics:
each pixel of the digital image is defined by a level of intensity of three compounds of different colour, the process comprising prior to the binarisation stage, a decomposition stage of the image according to a given colour connecting to each pixel of the image a level of intensity from among a number of possible levels greater than 2;
decomposition is completed according to one of the primary colours of the standard space of Nrgb colorimetry;
decomposition stage is completed according to the green compound of the standard colorimetry space;
binarisation stage is conducted by application of the Ridler algorithm to the decomposed image according to any given colour;
the process comprises, prior to the analysis stage, an elimination stage in the binarised image of at least one object having a number of pixels less than a first predetermined threshold;
the process comprises, prior to the analysis stage, a division stage, in the binarised image, of at least one object having a number of pixels greater than a second predetermined threshold, into as many objects as nuclei of cells corresponding to this object;
division stage comprises the ultimate erosion of said at least one object for supplying germs, then growth of said germs to determine lines of division for the object by application of the method known as watershed:
analysis stage comprises the counting of objects of the image.

In accordance with yet another aspect, the invention proposes a device for analysis of cellular samples, comprising:
a plate for receiving a multi-well box of samples to be analysed;
a microscope;
a digital camera connected to the microscope, the camera providing images in the form of pixels, each pixel being defined by a level of intensity of at least one colour or black and white compound from among a number of possible levels of intensity greater than two;
a system for moving the box placed in the plate relative to the microscope;
a computer controlling the moving system and the camera and receiving digital images supplied by the camera, the computer further comprising software using the analysis process of a digital image of a cellular sample according to the present invention described hereinabove.

According to a preferred embodiment, the computer is programmed to acquire a given number of images for at least one well of the box placed in the plate by control of the displacement system and of the camera, and to analyse said images by application of said software.

According to another aspect, the invention also proposes a process for selection of a culture medium, characterised in that it comprises the stages of culture of several cellular samples each in a different culture medium then analysis as described earlier.

According to another aspect the invention proposes a process for measuring the toxicity of a substance, characterised in that it comprises the stages of culture of a cellular sample in the presence of the substance, then analysis as already described.

According to yet another aspect, the invention also proposes a process for measuring the cytopathological characteristics of a virus, characterised in that it comprises the stages of culture of a cellular sample in the presence of the virus, then analysis as already described.

The invention also proposes a process for selection of pharmacological substances occurring in the illnesses of excess weight or obesity, characterised in that it comprises the stages of culture of cells in the presence of substances to be tested, the colouring of intracellular fatty acids, then the acquisition of at least one digital image of the sample and digital analysis of said image.

The invention proposes finally a process for selection of pharmacological substances occurring in osteoporosis, characterised in that it comprises the stages of cell culture in the presence of the substances to be tested, colouring of the cells, then the acquisition of at least one digital image of the sample and digital analysis of said image.

Other characteristics and advantages of the invention will emerge from the following description of a preferred embodiment of the invention, given by way of example and in reference to the attached diagram.

### DESCRIPTION OF FIGURES

FIG. 1 illustrates a multi-well box for cellular sample utilised with the device according to the present invention of FIG. 2.

FIG. 2 schematically illustrates the material part of a device according to the present invention. Detailed Description: it comprises a computer (not shown), a microscope 2 coupled to a camera 3, a lighting system 4 and a plate 5 for receiving a multi-well box 1 containing cellular samples to be analysed.

FIG. 3 illustrates an image example according to the green compound of the standard RGB space of a cellular sample coloured in magenta.

FIG. 4 illustrates the distribution of the pixels of an image according to their intensity.

FIGS. 5a and 5b illustrate the images obtained from the image of FIG. 3 after binarisation and selection of objects of small size in the first and of large size in the second.

FIG. 6 illustrates the image of the germs obtained after erosion of the objects of the image of FIG. 5b.

FIG. 7 illustrates the result of the growth in region from germs of FIG. 6, likewise showing the initial objects of FIG. 5b.

FIG. 8 illustrates the final image obtained by combination of the images of FIGS. 5a and 5b after scission of the attached nuclei.

FIG. 9 illustrates the results of a toxicity test conducted according to a process claimed by the invention.

FIG. 10 illustrates the results of measuring the density of lipids carried out according to a process claimed by the invention.

### DETAILED DESCRIPTION

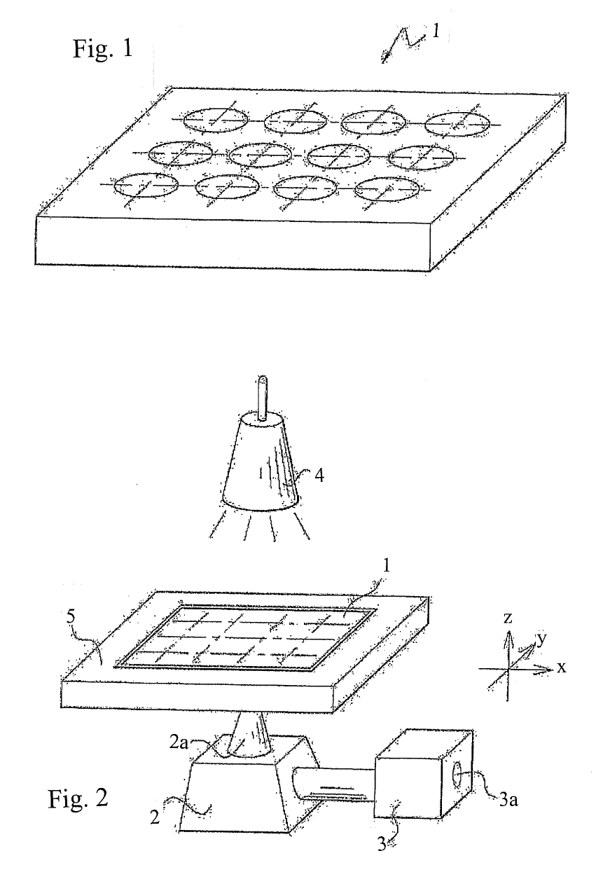

The multi-well box 1 can be of a type known per se. In general, the wells of a box 1 all have the same cross-section. An example of a multi-well box 1 having 12 wells is illustrated by FIG. 1. The wells are, in this case, arranged regularly in four columns having three wells each. Alternatively, this can be a multi-well box 1 having 96 wells, in which case the wells have a lesser cross-section and are arranged regularly in 12 columns having each 8 wells.

Each well is provided to receive a cellular sample to be analysed.

The microscope 2 can be an optical microscope known per se.

The device comprises motorisation for positioning the lens 2a of the microscope 2 in front of any of the wells of the box and therefore for observing the sample contained in the corresponding well. It also shifts the lens 2a in front of the same well in the event where it is desirable to successively observe a plurality of distinct zones of the sample of the same well, the field of observation of the microscope 2 covering only a small part of the surface of a well.

Preferably, the microscope 2 is fixed horizontally and its axis of observation is vertical (axis z), whereas the plate 5 is motorised for shifting the box 1 in a horizontal plane x-y in front of the lens 2a of the microscope 2.

The device comprises likewise motorisation enabling the microscope 2 to focus on the sample in the selected well. Preferably, the plate 5 is fixed vertically, whereas the lens 2a is motorised to be shifted vertically along axis z.

In addition, the microscope 2 is preferably of the inverse type. In other words, the lens 2a of the microscope 2 is placed under the box 1 and observes the sample contained in the well place in front of its lens 2a through the background of the box 1. For this, the box 1 is made of a transparent material, which can advantageously be a plastic material.

The utilisation of a microscope 2 of inverse type allows the focal distance for focusing the microscope on the sample contained in the well to be respected. On the contrary, in the case of observation from the top of the box, the respect of the focal distance can necessitate penetration of the lens 2a of the microscope 2 into the well, which is generally ruled out due to the size of the lens 2a.

The camera 3 digitally acquires the image of the sample supplied by the microscope 2. The camera 3 supplies the digital image to the computer via any adequate link 3a.

The camera 3 is preferably of colour type coding for each pixel three primary colours on a certain number of levels of intensity, preferably at least 16 levels for each compound so that the nuclei of the cells are sufficiently distinguished from the background and from the cytoplasm.

In fact, the camera 3 can advantageously be of CCD or tri-CCD type supplying a digital image in colour, for example of the classic type supplying the compounds R, V and B of each pixel with the intensity of each compound coded on 256 levels, and therefore allowing 2563 colours to be coded.

The lighting system 4 illuminates the wells of the box 1 located in front of the lens 2a of the microscope 2. In this instance, the lighting is effected from above the box 1. In other words, the microscope 2 observes the samples contained in the box 1 in transmitted light. The lighting system 4 can advantageously comprise filters for selecting a type of light given as a function of the nature of the sample to be analysed. Similarly, the intensity of the lighting can be adjusted to select an intensity given as a function of the nature of the sample to be analysed.

The exposure time and the diaphragm opening of the camera 3 for acquiring an image provided by the microscope 2 can likewise be variable and selected as a function of the nature of the sample to be analysed.

For full automation of the device, it is advantageous for the computer to control all the elements described due to adequate open-loop control software. The computer can thus control the shifting of the plate 5, the focusing and the enlarging of the microscope 2 and the camera 3. As for the camera 3, the computer controls the triggering of the camera shot, as well as adjusting of the exposure time and diaphragm.

The lighting system 4 can be adjusted manually, since the intensity of the lighting and the filters selected are generally the same for all the wells of the same box 1 and therefore do not require intervention during successive analysis of the assembly of wells of the box. All the same, the lighting system 4 can advantageously be piloted by the computer, allowing fuller automation and avoiding any possible errors in manual adjustment concerning the light intensity or the filters selected.

By way of example, equipment commercially available can be utilised as follows:
microscope 2: Nikon TE 2000-E with a motorised plate 5 x-y of PRIOR type;
3 CCD camera: Nikon DMX1200.

The computer can be of conventional type, such as a compatible PC equipped with input/output interfaces required to control the device and receive digital images from the camera 3. In standard fashion, it also comprises user interfaces such as keyboard and display monitor.

The open-loop control software of the microscope 2, the camera 3, the lighting system 4 and the plate 5 can be LUCIA-G software marketed by Laboratoryhnaging (The Czech Republic).

We will now describe the preparation of the cellular samples to be analysed, which are places in the wells of a multi-well box 1.

Cells are cultivated in the wells of the multi-well box 1 under different culture conditions for analysing the consequences of these experimental conditions, for example on cellular growth, on parameters of cellular cycle or on the frequency of differentiation. On completion of experimental time, the cells are coloured and optionally fixed, with analysis able to be done at will on living or fixed cells. If the cells are fixed, they are preferably fixed before being coloured.

Fixing the cells stops the cellular evolution of the samples so a to ensure that the defined experimental time is respected, especially in the event where analysis of the sample does not occur immediately on completion of this period. In addition, fixing the cells also allows their distribution to be immobilised in the sample for the sake of reliability of analysis in the event where distinct zones of the sample are observed successively by microscope 2.

The cells are coloured to reveal the translucid naturally nuclei. For this purpose, when it comes to colourings, it is an advantage to employ cytochemistry colouring, especially after having resorted to alcoholic fixing. The advantage of cytochemistry colourings is simplicity of application, robustness, good signal on noise ratio and very good conservation. Further, analyses can be done simply in white light. As for alcoholic fixing, it is advantageous as it constitutes a form of rapid fixing, which does not interfere with colouring techniques.

The fact of revealing the nuclei allows the inventive device to acquire images of the sample and process them automatically to determine for example the number of nuclei of the sample, their morphology and characterise their distribution. As a consequence, it also aids in quantifying the number of cells in the sample from the number of nuclei observed. The majority of cells of mammals has a single nucleus only.

For more reliable analysis, several wells of the box 1 can contain samples cultivated under identical conditions. Therefore, consideration can be give to variations intrinsic to biological and experimental systems between samples of the same condition. This especially allows analyses done on these wells to be averaged and therefore to have a more reliable result. In simple terms, it can be agreed that each column of wells of the box 1 is dedicated to the same culture condition. The number of wells containing samples of the same condition—in other words, the number of wells effectively utilised in each column in our example—can be selected as a function of the admissible error rate for the result of the analysis, this rate diminishing with the increase in the number of wells with the same culture condition.

We will now describe the analysis process used by control and analysis software run by the computer of the device according to the present invention described hereinabove. This control and analysis software controls the material part of the device by means of the abovementioned open-loop control software and conducts analysis of the digital images supplied by the camera 3. Before starting analysis of samples by the computer, an operator places on the plate 5 a multi-well box 1 containing cellular samples to be analysed in its wells.

In a first stage, the computer asks the operator to indicate the type of cellular samples to be analysed. This can be done selectively by the operator in a predefined catalogue of types proposed by the computer. The type of sample at the same time takes into consideration the type of cells to be analysed and the type of histological colourings applied to them.

In the event where the device is provided to function with different predetermined types of multi-well boxes 1 such as the abovementioned boxes 12 wells and 96 wells, the computer asks the operator to indicate the type of box 1 placed in the plate 5. Alternatively, automatic reconnaissance of the type of box 1 can be provided by the device, for example by means of a mark of colour specific to the type of box and placed at a predetermined site of the latter. The computer pilots the plate 5 to observe the mark by microscope 2 and provide the digital image corresponding to the computer by means of the camera 3. By determining the colour of the mark, the computer determines the type of box 1 concerned.

As pointed out, it can be provided that the box 1 has, for each culture condition, a given number of wells having samples of this culture condition. This number can be lowered by choice of the operator to allow him to select the acceptable analysis error rate. In this case, the computer asks the operator to indicate this number. The distribution topology of the samples of the same condition in the wells of the box 1 is preferably predefined to prevent the operator from having to supply it to the computer.

In a second stage, if the device allows, the computer regulates the lighting of the lighting system 4 as a function of the type of cellular samples previously selected by the operator. Failing this, it is the operator who adjusts the lighting system 4 if it is no controlled by the computer. In this case, the computer can optionally indicate which adjustments are to be made.

In a simplified variant, the lighting system 4 comprises no selectable filters and/or filters for adjusting intensity. In particular, it can be provided that the lighting is always the same, irrespective of the type of sample concerned, for example white light.

In a third stage, the computer acquires images of the samples to be analysed. For this, it successively places the wells of the box 1 containing the samples in front of the lens 2a of the microscope 2 by controlling the plate 5.

For each well, the computer has the camera 3 take a predetermined number N of distinct images of the sample by each time shifting the wells in front of the lens 2a by control of the plate 5. The computer controls the focusing of the microscope 2. It also proceeds with adjusting of the diaphragm and the exposure time of the camera 3, as well as enlargement of the microscope 2; these adjustments can be a function of the type of sample selected.

These digital images are transmitted to the computer as they are being acquired. In the example of a classic CCD or tri-CCD camera with 2563 colours, the computer receives the values of the compounds R, V and B for each pixel of an image, the intensity of each being coded on 8 bits and therefore providing 256 levels of intensity for each compound. The computer stores these images preferably on its hard disc.

The N images are preferably inscribed inside the wells so as to prevent the images form comprising parts external to the well. Failing this, analysis of the images would require additional processing to distinguish the interior of the well from the exterior.

The N images can be taken in predetermined positions of the sample or in random positions.

Preferably, each image covers a zone of the sample, which is specific to it and does not cover all or part of other images so as to avoid redundancy, which would diminish the representativity of the images, acquired relative to the whole of the sample.

In a fourth stage, the computer decomposes each colour image into an image according to a given single colour, which clearly distinguishes between the objects to be analysed, the nuclei, and the background of the image.

The single colour in which each image is decomposed is a function of the type of sample to be analysed, and more particularly of the histological colouring undertaken.

Typically, to provide good distinctiveness capacity, decomposition of the image can be undertaken according to the colour of the histological colouring, or according to the colour complementary to the latter.

In the case of cytochemistry colouring in magenta, it is advantageous for the computer to decompose each image colour into an image according to the green compound of the standard RGB space (note, in conventional terms Nrgb). In fact, G the green is the complementary colour of magenta. Further, the standard RGB space provides better discrimination in comparison to the R, V, B compounds provided by the camera, due to the fact that the standard space is less sensitive to variations in luminosity. Therefore, for each pixel of an acquired image, the computer calculates the level of intensity of the green compound ‘g’ of the standard RGB space as follows:
g=G/(R+G+B)
with R, G and B the values of the red, green and blue compounds provided by the camera 3.

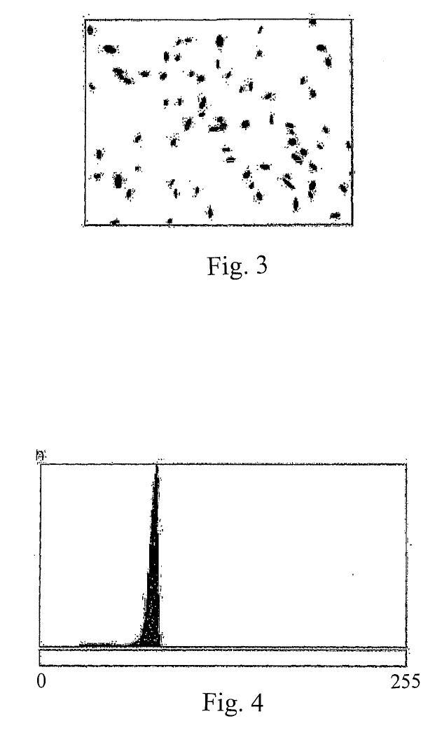

FIG. 3 illustrates an example of an image according to the green compound of the standard RGB space of a cellular sample coloured in magenta. The weaker the level of intensity, the darker the representation of the pixel. Therefore, the pixels of the nuclei exhibit a level of intensity clearly weaker in comparison to the background pixels, which exhibit a heightened level of intensity.

In a simple variant, instead of decomposing each image according to a compound of another calorimetric space, the computer can retain each image according to one of the R, V, B compounds provided by the camera 3, for example the image according to the V compound in the case of cytochemistry colouring in magenta, even though the distinctiveness is less.

In an even simpler variant, the camera 3 supplies images in black and white instead of being in colour, in which case this fourth stage is omitted.

In a fifth stage, the computer supplies a binarised version of each image originating from the fourth stage discriminating the nuclei and the background. For this, a threshold of intensity is defined to discriminate the pixels considered as belonging to the nuclei of the pixels considered as belonging to the background. In other terms, the computer compares the intensity of each pixel of the image originating from the fourth stage at this threshold and assigns it a first value -0- or a second value -1- as a function of the result of the comparison. As a result, we consider that the value ‘1’ corresponds to the pixels of nuclei and ‘0’ to the rest.

For the sake of reliability of analysis, it is preferable for the computer to determine this threshold each time, rather than to apply a predetermined fixed value of this threshold for a given type of cytochemistry colouring, given the variability of the colouring of the nuclei. In other words, it is preferable for the computer to determine this threshold specifically for each image.

To determine the threshold to be applied, the computer can employ any adequate technique known per to automatically determine such a threshold.

The technique applied by the computer can be a function of the type of sample.

With this aim, the computer can especially apply to the image originating from the fourth stage an algorithm utilising the iterative Ridler method, known per se. This algorithm produces an excellent result in the case of a bi-modal distribution histogram of the pixels according to their intensity. The distribution is bi-modal in the event where just the nuclei of the cells are coloured by the histological colouring. FIG. 4 illustrates such a histogram for the image of the cellular sample of FIG. 3. The axis of the abscissae illustrates the light intensity coded in 256 levels and the axis of the ordonates shows the number of pixels.

In certain cases, distribution is tri-modal. This can be the case when the cytoplasm of the cells is likewise coloured, but to a lesser degree than the nuclei, during histological colouring. In this case, the threshold can be determined by two successive applications of the Ridler algorithm. The first application supplies the threshold for discriminating the background of the rest: nucleus and cytoplasm in our example. A second application of the algorithm to that part of the histogram comprising only the rest, that is, the part of the histogram limited to this threshold, provides a second threshold discriminating the nuclei of all the rest: at the same time from the background and the cytoplasm in our example.

For the computer to apply the Ridler algorithm once or twice this can be a function of the type of samples. But it is preferable for the computer itself to determine, in a manner known per se, if an image has bi-modal or trimodal distribution so as to apply the Ridler algorithm either once or twice.

As mentioned, it is preferable for the computer to determine this threshold for each image. In a simplified variant, the computer determines this threshold for a single image of a well and utilises it also for the other images of this well, or even for the images of the other wells having samples of the same condition, or even in the end for all the images relative to the wells of the same box 1.

It is preferable that, in a sixth stage, the computer eliminates from the binarised image the objects of small size, since they correspond not to nuclei, but to artefacts. For this, the computer can simply count the number of pixels of each object and eliminate them in the event where this number is less than a predetermined number experimentally, for example 50 pixels for enlargement×150 of the microscope 2. This predetermined number is advantageously a function of the type of cellular samples. In our example, eliminating an object consists of setting the value of the pixels of the object to ‘0’.

In a seventh stage, the computer can advantageously conduct a process on the image to distinguish possible nuclei attached to large nuclei.

To do that, the computer can create two images distinct from the binarised image originating from the sixth stage. The computer retains in the first image all the objects of the binarised image, each corresponding to a nucleus isolated by way of the small size of the object.

On the contrary, the computer retains in the second image the larger objects, which can in fact correspond either to a large isolated nucleus, or to several attached nuclei. To do this, the computer places the objects having a size less than a predetermined value singly in the first image, for example 450 pixels for an enlargement×150 of the microscope 2, and it places the other objects in the second image. Here too, in our example, the pixels of the objects not taken up in one of these images are set to the value ‘0’.

This predetermined value can be determined experimentally. It can be a function of the type of cellular samples.

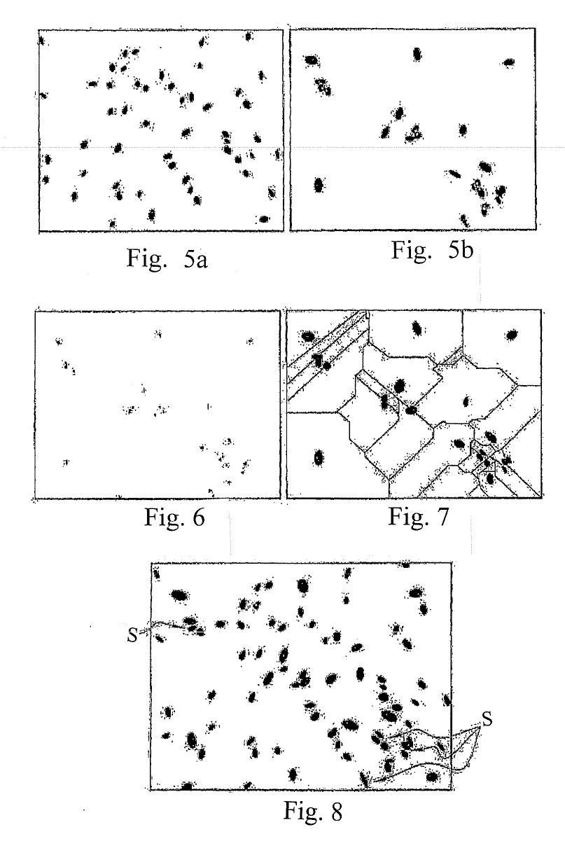

FIGS. 5a and 5b respectively illustrate the first image and the second image obtained in the case of the sample image of FIG. 3.

The computer then processes the second image to divide the objects corresponding to several nuclei. Such an object is divided into as many parts as nuclei it represents.

For this purpose, the computer can advantageously employ the method known per se known as watershed. To do that, from a copy of the second image the computer erodes each object to obtain its germs. Each germ corresponds to a cell nucleus. FIG. 6 illustrates the image of the germs obtained after erosion of the objects of the image of FIG. 5b.

The computer then proceeds with regional growth from the germs, the growth being stopped when two regions meet. FIG. 7 illustrates the result of the region growth by showing the initial objects of FIG. 5b. The frontiers between regions then serve to segment the objects of the second image. To this effect, the computer sets the pixels of the frontiers to the value of the background in the second image; in our example, it allocates the value ‘0’ to these pixels. As a consequence, the objects are scindes in consequence as much in parts as germs obtained by final erosion.

The second image after scission of the nuclei is, if required, combined with the first image, which contains the small-size objects reputed to each correspond to an isolated nucleus. The result of this is an image showing all the nuclei of the sample, each separated from the others. FIG. 8 illustrates the image resulting obtained for the sample image of FIG. 3 with the arrows designated by ‘S’, which marks off a few segmentations resulting from the seventh stage.

In an eighth stage, the computer proceeds with analysis of the objects contained in the image originating from the seventh stage by image analysis techniques known per se.

In particular, it counts the number of objects contained in the image, which supplies the number of nuclei contained in the sample, since each object corresponds to a nucleus.

By way of non-limiting example, the computer can likewise determine for each nucleus one or more of the following items of information:
the surface of the nucleus;
the perimeter of the nucleus;
the main direction;
the coordoninates in the image;
the length of the small axis and the large axis of the ellipse which best models the object.

The computer can evidently save these results in a file.

In a ninth stage, the computer can determine information relative to the complete sample of a well from the data obtained for all the images of this well. Therefore, it can estimate the total number of nuclei contained in the well as a function of the number of nuclei contained in the N images acquired from this well in view of the predetermined ratio between the partial surface of the well covered by the N images and the total surface of the well. It is also possible to determine the cellular density by calculating the number of nuclei present, as already described, and by dividing this number by the surface of the image.

The computer can likewise establish statistics on each well with respect to the other characteristics determined, especially those listed previously.

In the case of a plurality of wells containing samples of the same condition, the computer can average the information relative to these wells to decrease the error rate.

From there, the computer can also calculate the number of cellular divisions and the time necessary for the number of cells to double if the operator supplies it with the number of cells seeded originally in the wells of the box 1 and the time of culture by considering that the growth of the cells is exponential.

Of course, the computer can store, for example in the form of files, the results of analysis, as well as the images acquired and/or obtained after processing according to the different stages of the process.

For each type of cells considered, the choice and parameters procuring the best results of analysis can be determined experimentally and are then employed automatically by the inventive process. Therefore, the process can be used with cytochemical colourings other than magenta. For each type of cell, the colouring providing clarity of the nuclei relative to the rest can be determined experimentally. Likewise, the adjusting of the lighting if it is provided and the adjustments to the camera—exposure time and opening of the diaphragm—taking shots can likewise be determined experimentally for each type of sample so as to provide images having a good contrast of the nuclei relative to the background.

In the third stage, the number N of images taken for the sample of a well is at least one. But, of course, the greater the number N, the larger the surface of the sample covered by the images and the information estimated by the computer for any given well will show a low error rate. This number N can be determined experimentally to obtain an error rate acceptable for analysis. By way of example, 300 distinct images are acquired from each well of a box 1 with 12 wells, each well having a diameter of 2.159 cm for 1 well and an area of 3.66 cm² with enlargement×150 of the microscope 2. These 300 images cover around 90% of the total surface of the well.

By way of example, the process of the invention can be utilised on the basis of the Image J® software, available from the National Institute of Health in the USA.

The use of nuclei marks by histological colourings can advantageously contribute to sensitively and quantitatively analysing with the inventive device the consequences of the different conditions of culture on cellular density and therefore on cellular growth. To these quantitative results can be added an image digitised resulting from the cellular samples provided by the device, which constitutes an archive and reference document. This method parameters the experimental approaches and therefore increase tracability therefrom. An advantageous embodiment utilises nuclear colouring sch as Giemsa, allowing colouring of the cellular nucleus which is not DNA colouring. Other nuclear reagents non-specific to DNA can be utilised and are well known to the specialist, such as Orth carmine, Cresyl violet, Safrinine Q, Malachite green, Violet crystal, Hematoxyline, Eosine, Wright colouring, Methyl green or Thionine. The result is greater homogeneity of the signal emanating from the nucleus and absence of variation in the intensity of the signal as a function of the stages of DNA replication during the cellular cycle.

It is likewise possible to make use of the inventive device and the process implemented with colouring techniques other than cytochemistry colourings.

Therefore, recourse can be made to specific colourings of the cells, in which case it is advantageous to employ immunoenzymatic techniques with antibodies characterised by the fact of their specificity and the existence of a wide choice of specific antibodies. In particular, techniques of immunoperoxidase can be employed, the results of which are observable under white light. The use of these specific colourings especially allows analysis with the inventive device, either of the parameters of cellular cycle, or of the differentiation parameters. By way of example, the number of cells in phase S can be determined after marking of the cells by BrdU and recognition of the positive nuclei by means of an antibody directed against the BrdU. Antibodies directed against different proteins implicated in the control of the cellular cycle, such as PCNA, P21, P16 and cycline A, can also be utilised. Analysis of the differentiation can be done by using antibodies directed against specific transcription factors of a particular state of differentiation. By way of example, for muscular differentiation, use is made of antibodies directed against the specific transcription factors of muscular tissue, proteins of the MyoD family.

The colouring of the cells can likewise be obtained by the use of fluorescent markers. Vital colourings such as bisbenzimide, which are bound with a significant affinity to DNA help to follow the growth on living cells and analyse modifications of the organisation of nuclear DNA, which are associated with apoptosis. The fluorescent markers associated with antibodies directed against membranar proteins helps to enumerate the cells having these markers.

Of course, the present invention is not limited to the examples and the embodiment described and illustrated, but it is susceptible to numerous variants accessible to the specialist. In particular, the images acquired can each be processed completely according to stages four to eight prior to moving on with full processing of the following image acquired. In addition, it is not necessary to wait until all the N images have been acquired in the third stage to commence processing of those already acquired.

With respect to the iterative Ridler method, reference can be made to the article by Ridler, Calvard, Picture Thresholding Using an Interactive Selection Method, IEEE transactions on Systems, Man and Cybernetics, 1978.

With respect more generally to the determination of thresholding reference can be made especially to:
T. Pun, A new method for gray level picture thresholding using the entropy of the histogram, Signal Processing, 1980, vol. 2, p. 223-237;
N. Otsu, A threshold selection method from gray level histograms, IEEE Transactions on systems, man, and cybernetics, vol. 9, p. 62-66.

With respect to the watershed method, we can refer to:
R. Gonzales, R. Woods, Digital Image Processing, Addison Wesley, 1993, p. 443-458-0. Lezoray, Histogram and watershed-based segmentation of color images, Proceedings of CGIV 2002, April 2002, p. 358-362.

All the abovementioned documents are incorporated by reference into the present description.

The inventive device and the process employed can have a wide range of applications.

A first example concerns the construction of predictive cellular toxicity test implemented in the form of a high-rate screening machine. At the level cellular the consequences of toxicity are multiple. The more frequent of these are modifications to the parameters of cellular growth, the cellular death by apoptosis or by necrosis, morphological and functionnal modifications. The culture, then the analysis automated according to the present invention of cells cultivated in multiple plates of for example 96 wells—enabling multiplication of the number of analyses—provides high-rate predictive toxicological systems. By way of image analysis it is possible to mine quantitative data on cellular growth, on cellular death, morphology and cellular functions. The systems of ex vivo cultures control the cellular environment and utilise specific cells. Therefore, the use of cells originating from different tissues, such as kidney, muscle, skin, nervous system, vessels, of the organism can test the toxicity of molecules on these different tissues and therefore construct specific toxicological tests.

Different embodiments of the present invention applied to cellular tests are described herein below.

I Cellular counting by image analysis to determine cellular density for selecting a culture medium

Cellular growth depends on combinations of factors, which compose specific codes of growth. The vast majority of elements necessary for ex vivo cellular cuture is both known and easy to access. The question is to define the combinations of these elements making up these codes.

This approach builds a simple and versatile system for analysing the cellular density quantitatively and the frequency of expression of a marker and for storing cellular images. The usual methods for determining the number of cells are associated with stages of cellular detachment (Coulter) or with stages of cellular lysis (MTT). Owing to this, these techniques dispel any morphological notion and result in significant information loss.

The process according to the present invention analyzes the role of the presence of growth factor on cellular density and on nuclear morphology.

The stages are the following. The different cellular types are cultivated on multi-wells of 12 to 96 wells under different conditions for culture to analyse the consequences of these experimental conditions, either on cellular growth, or on parameters cellular cycle and on the differentiation frequency. On completion of the experimental time, the cells are fixed, then coloured. For the cytochemical colouring, we use nuclear histological colourings such as Giemsa after alcoholic fixing. Examples of other histological colourings are Orth carmine, Cresyl violet, Safrinine Q, Malachite green, Violet crystal, Hematoxyline, Eosine, Wright colouring, Methyl green or thionine.

The cells thus coloured are observes using the device and analysis proceeds according to the present invention, and more particularly with the equipment given as an example.

With this simple, robust, versatile process and a good signal to noise ratio we are able to sensitively and quantitatively analyse the consequences of the different culture conditions on cellular density and therefore on cellular growth. Associated with these quantitative results are a resulting digitised image of cells, which will constitute an archive and reference document. This method of proceeding allows us to parameter our experimental approaches and therefore increase their traceability, gauge of quality.

In this experiment the cells utilised are human muscular cells.

In the first instance, the cells are amplified in culture in the presence of human serum (PAA laboratory) then seeded in the various conditions described. Growth factors can be added to the culture medium so as to promote cellular growth. The cells are seeded in multiples of 12. The substrate utilised is gelatin and the seeding density is 5000 cells per well.

Experimentation Conditions:
type of box: 2 multi-well of 12 (TPP)
substrate: gelatin
density: 5000 cells/well
change of medium: 24/05/02 27/05/02 29/05/02 31/05/02
culture period: 7 days
Giemsa coloration:

After aspiration of the culture medium, the cells are washed with PBS then fixed with 100% ethanol. Ten minutes later the cells are washed in water then coloured with a solution of 10% Giemsa for 10 minutes. The final stage is washing in water.

Recording Pictures

The images are obtained with the device according to the present invention, more particularly with the equipment given as an example.

The results of this study are presented in Table 1.

TABLE 1
Results of the selection of media X1, X2, X3 and X4 are
different additives based on mixtures of growth factors.

| No. of | No. of | No. of | Average | Average | Average | Average | Average | Nuclei | |
|---|---|---|---|---|---|---|---|---|---|
| well | photos | nuclei | surface | perimeter | ellipsis L | ellipsis I | angle | per photo | Compactness |
| 11 | 33 | 4428 | 407.32 | 81.15 | 28.68 | 16.95 | 92.22 | 134.18 | 5.0 |
| 13 | 24 | 2516 | 428.78 | 83.99 | 29.03 | 17.54 | 87.11 | 104.83 | 5.1 |
| 15 | 22 | 2859 | 327.34 | 76.66 | 27.92 | 14.05 | 89.64 | 129.95 | 4.2 |
| 17 | 38 | 4473 | 413.46 | 82.25 | 28.6 | 17.23 | 94.59 | 117.71 | 5.0 |
| 21 | 28 | 222 | 650.14 | 115.07 | 36.58 | 20.82 | 85.44 | 7.93 | 5.6 |
| 23 | 21 | 197 | 531.57 | 92.14 | 30.93 | 20.58 | 90.56 | 9.38 | 5.7 |
| 25 | 26 | 2007 | 327.01 | 74.93 | 27.56 | 14.17 | 88.63 | 77.19 | 4.3 |
| 27 | 24 | 2644 | 338.12 | 78.03 | 28.13 | 14.42 | 100.38 | 110.17 | 4.3 |

| No. of well | Compounds |
|---|---|
| 11 | DME/F12 + 1% Human serum + ins + compound X4 |
| 13 | DME/F12 + 1% Human sertum + ins + compound X3 |
| 15 | DME/F 12 + 1% Human senum + Ins + compound X2 |
| 17 | DME/F12 + 1% Human serum + compound X1 |
| 21 | DME1F12 + 1% Human serum |
| 23 | DME/F12 + 1% Human serum + ins |
| 25 | DME/F12 + 1% Human serum + FGF |
| 27 | DME/F12 + 1% Human serurn + Ins + FGF |

II Image Analysis and Toxicological Tests

Defining the toxicological profile of a molecule is an indispensable stage for envisaging therapeutic application. The systems of cells provide helpful tools in this perspective.

Fatal accidents with inhibitors of the synthesis of cholesterol of the statin family have put muscular tissue on the first plane as toxicological target. Poor evaluation of this risk known by Bayer for Cerivistatin had considerable human and economic consequences.

Very many drugs are capable of causing myopathies. In serious cases, we witness significant lysis of muscular tissue (rhabdomyolysis) even if the mechanisms is still not well known. Several hypotheses have been put forward. Certain of these invoke augmentation of the membranar permeability and others cause anomalies at the mitochondria level.

In the great majority of cases, these are accidents survenant in un context of polychimiotherapy suggesting the role of drug-related interactions (macrolides, immunosuppressors, anticancerous, fibrates, cocaine, antiproteases of HIV, anaesthesics . . . ).

Amongst the numerous agents implied are: P450 cytochromes, molecules implicated in apoptosis such as BCL2, antioxidants, proteins of the NFKb complex, PPARs or surgical interventions.

With the exception of critical accidents, threatening the vital pronostic (rhabdomyolysis), the clinical signs of a muscular atteinte are frustres, muscular pain (myalgia), tiredness, cramps and biological signs outside of critical accidents the CPK are very frequently normal. In the case of statins, recent data indicate that the subjects having muscular attacks show neither correlations between the level plasmatic of this pharmacological agent and the toxic attack, nor elevation of CPK. In these cases histology reveals in the muscular tissue modifications of mitochondria (swelling) and accumulations lipidic droplets.

The multiplicity of hypotheses, the role of drug-related interactions, the dearth of clinical signs and biological signs oblige the creation of new tools for providing and understanding the toxicity at the muscular tissue level.

In this case, the animal models are heavy and therefore difficult to work with. To resolve these questions we have built predictive cellular models of muscular toxicity.

In this experiment, we utilised normal human muscular cells for testing the toxicity of industrial statins.

Experimentation Conditions:
type of box: 2 multi-well of 96 (TPP)
density: 2 500 cells/well
standard culture medium containing growing doses of Lovastatine, Cerivistatine, Atorvastatine, Pravastatine, Fluvastatine or Simvastatine in concentrations of 0, 0.01, 0.05, 0.1, 0.5 and 1 gM

Experimentation Follow-Up:
11/07: Change of media
13/07: Coloration. Culture period: 5 days

Giemsa Coloration:

After aspiration of the culture medium, the cells are washed with PBS then fixed with ethanol at 100%. Ten minutes later the cells are washed in water then coloured with a solution of Giemsa at 10% for 10 minutes. The final stage is washing with water.

Recording Pictures:

The images are taken by a device according to the present invention, and more particularly with the equipment given as an example.

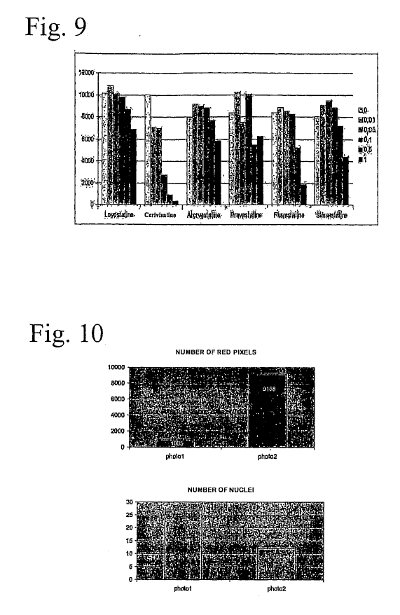

The digital execution is presented in FIG. 9. This figure reveals the heightened toxicity of Cerivisatine. This molecule of statins class has caused a very large number of toxic muscular accidents.

This experiment shows that the association of cellular type adapted with systems of automated analysis develops specific toxicological tests. The experiments being conducted in multi-well microplate of 96 wells allow the development of high-flow analysis.

III Image Analysis and Virological Tests

The functionality of the viruses is detected by their cytopathological capacity on specific target cells. One of the consequences of the viral infection is cellular lysis.

This property is utilised for a test, which enables the number of functional viruses to be detected.

In brief, the different stages of this test are:
culture in microplate of 6 wells of the target cells
viral infection by an increasing quantity of virus in gelose. This stage can last for several days
revelation of the range of lysis after fixing and colouring
manual counting of these ranges of lysis.

The principal limitations of this test are complexity of the different stages depending on knowhow. As for the toxicology tests we use the culture in microplate of 96 associated with image analysis for numbering cells and thus quantifying results. In brief, the different stages of this test are:
culture of the target cells in microplate of 96 wells
direct viral infection (without gelose) by an increasing quantity of virus
(alcoholic) fixing and colouring with Giemsa (or alternatively Orth carmine, Cresyl violet, Safrinine Q, Malachite green, Violet crystal, Hematoxyline, Eosine, Giemsa, Wright colouring, Methyl green or Thionine).
the analysis of the cultures with the device and analysis process according to the present invention, and more particularly with the equipment given as an example.

The advantages of this test are simplification of the biological stages, automation of reading the results. In this way it is possible to construct automatons dedicated to reading this type of test.

IV Image Analysis for Determining Cellular Accumulation of Lipids

The metabolism of lipids is a vital source of energy and this particularly for muscular tissue or oxidation measurements based on the production of CO₂ can be carried out directly on muscular tissue or on isolated and cultivated muscular cells.

The oxidative deficits of fatty acids are not limited to monogenic pathologies.

These anomalies are also observed in excess weight illnesses such as obesity. The reduction in oxidation capacities of fatty acids, by peripheral tissues such as muscle, is linked to certain forms of excess weight.

In these conditions of energetic imbalance, the fatty acids not metabolised in excess are then stored by the adipocytes and by other cellular types.

When non-oxidised, the fatty acids also serve as substrates for the formation of molecules such as ceramides implicated in apoptosis. The targets of this lipoapoptosis are B-Langerhans cells of the pancreas and cardiac cells and is one of the physiopathological mechanisms of the cardiac and pancreatic insufficiency observed in obesity and type 2 diabetes.

The utilisation of specific cytochemistry colouring of lipids such as Red Oil helps to visualise the intracytoplasmic accumulation of fatty acids at the cellular level.

This process yields this type of quantitative colouring.

The digital acquisition of the images observed by microscope with the device according to the present invention enables them to be analysed for extraction of the quantifiable data; such data are presented in FIG. 10.

This type of approach combining target cells, specific histological colourings and automatable processes of analyses helps to develop cellular tests for screening pharmacological agents occurring in obesity or the conditions of excess weight.

By changing target cells (cells adhering to the bone marrow) and histological colouring (Von Kossa) this cellular test targets pharmacological agents occurring in osseous formation (osteoporosis).

1. A process for analysis of a cellular sample, comprising the stages of:
a) colouring of the nuclei of the cells of the sample;
b) acquisition of at least one digital image of the sample; and
c) digital analysis of said image, characterised in that colouring stage a) of the nuclei of the cells is DNA-non-specific colouring.

2. The process as claimed in claim 1, characterised in that colouring stage a) comprises colouring by a reagent selected from the group consisting of: Giemsa, Orth carmine, Cresyl violet, Safrinine Q, Malachite green, Violet crystal, Hematoxyline, Eosine, Wright colouring, Methyl green and Thionine.

3. The process as claimed in claim 1, characterised in that colouring stage a) comprises colouring with Giemsa.

4. A process for selecting a culture medium, characterised in that it comprises the stages of:
culture of several cellular samples each in a different culture medium;
analysis of the cellular samples by a process as claimed in any one of claims 1 to 3.

5. A process for measuring the toxicity of a substance, characterised in that it comprises the stages of:
culture of a cellular sample in the presence of the substance;
analysis of the cellular sample by a process as claimed in any one of claims 1 to 3.

6. A process for measuring the cytopathological characteristics of a virus, characterised in that it comprises the stages of:
culture of a cellular sample in the presence of the virus
analysis of the cellular sample by a process as claimed in any one of claims 1 to 3.
